(19) United States
(12) Patent Application Publication
(10) Pub. No.: US 2018/0228301 A1
(43) Pub. Date: Aug. 16, 2018

(54) MULTIPURPOSE COVER FOR SHIELDING A CHILD FROM ENVIRONMENTAL ELEMENTS AND METHOD OF USING SAME

(71) Applicant: Love My Life Boutique Inc., Calgary (CA)

(72) Inventor: Evangeline Winfield Kmiec, Calgary (CA)

(21) Appl. No.: 15/893,410

(22) Filed: Feb. 9, 2018

Related U.S. Application Data
(60) Provisional application No. 62/457,628, filed on Feb. 10, 2017.

(30) Foreign Application Priority Data
Feb. 10, 2017 (CA) 2957565

(51) Int. Cl. A47D 15/00; B62B 9/14; B62B 3/14; A41D 1/215

(52) U.S. Cl. CPC A47D 15/00; B62B 9/142; B60N 2/26; A41D 1/215; B62B 3/1436

(57) ABSTRACT

A multipurpose cover, and method of use thereof, for shielding infants or young children from environmental elements, includes a wholly resilient fabric defining a cavity therein, the body having an exterior layer, extending from a lower end to an upper end, the exterior layers having an interior surface and an exterior surface, the upper and lower ends defining upper and lower openings into the cavity respectively, the resilient body having a releasable fastener adapted to releasable close a third, vertically extending opening into the exterior layer into the cavity, wherein the body tapers so as to narrow in width from the lower end to the upper end, and wherein the cover is adapted to be releasably mounted around and over a circumference of a container or the like so as to at least partially cover an upper opening into the container defined by the circumference.

### CROSS REFERENCE TO RELATED APPLICATIONS

This application claims priority from United States Provisional Patent Application No. 62/457,628, filed on Feb. 10, 2017, entitled: “Multipurpose Cover For Shielding A Child From Environmental Elements and Method Of Using Same” and Canadian Patent Application No. 2,957,565, filed on Feb. 10, 2017, entitled: “Multipurpose Cover For Shielding A Child From Environmental Elements and Method Of Using Same”, entireties of which are incorporated herein by reference.

### TECHNICAL FIELD

The present disclosure relates to a cover for shielding babies or children in an open vessel, container, or the like. In particular, this disclosure relates to a multipurpose cover for shielding babies or children from environmental elements when travelling in a container or the like, such as a baby car seat or stroller.

### BACKGROUND

When transporting an infant or a young child from place to place, parents and other caregivers (herein referred to as caregiver) will often use an open vessel, such as infant car seats or baby strollers, to transport the infant or young child (herein referred to as child) from place to place. When doing so, caregivers will typically be faced with the issue of needing to shield the child from various environmental elements during the active transportation. For example, when moving the child into a vehicle, a caregiver will often wish to strap the child into his or her car seat and then carry the car seat with the child in the seat, out to the vehicle. However climates where there is a cold wind, rain, or snow at the time of transport, caregivers often either place some kind of blanket or cover over the child seat so as to protect the child as much as possible from the weather elements and keep the child warm and dry, or they clothe the child in heavy clothing such as a winter jacket. Often, caregivers may just throw a blanket over the front of the child car seat to accomplish shielding. However, a problem with that method is that the blanket may easily fall off of the car seat, or be blown off by the wind, while it is being carried into the vehicle. Furthermore, if the blanket is densely woven, it may not be breathable enough so as to allow enough oxygen to reach the child. Furthermore, the blanket is not intended for this purpose so will often fall out of place and only act as a partial shield to only partially protect the child from cold temperature and precipitation that may be falling during transport to and from the vehicle. If the child is dressed in a winter jacket, to the applicant's understanding this may cause problems with the car seat in which the straps, when over the coat, are not sufficiently snug against the child to prevent ejection of the child from the seat in the event of an accident.

Similar issues may be encountered during transportation in warmer climates. For example, when a caregiver is taking a child out for a walk in a stroller, it is often desirable to shield the child from the sun and its associated UV rays which may cause damage to exposed skin, and additionally, certain environments may have various types of bugs or insects that the caregiver wishes to shield the child from during the walk, such as wasps, mosquitoes, and other nuisance insects. Again, a caregiver may simply use a blanket draped over the canopy that is typically a part of the stroller; however, because the blanket is not designed for this purpose, it will often inconveniently slip off during transport and may not effectively block the child from insects and harmful UV rays.

Other situations in which it may be desired or necessary to shield an infant or child from various environmental elements include: a rocking baby swing or bassinette when a child for example may be sleeping or resting in outdoors, or use of such equipment indoors where it is desired to shield the child from noise and light while the child is resting; use as a barrier against germs, dirt and similar environmental elements that may be found on the surfaces of a shopping cart, a baby swing on a playground or a high chair; and instances where a mother wishes to breastfeed her child in public and desires privacy for herself and the breastfeeding child, as well as to shield the child and the mother's breast from environmental elements, including sunlight, rain, snow, wind and cold temperatures.

Various different attempts have been made at creating a cover that would be useful for all of the different types of situations mentioned above. In some instances of which the applicant is aware, some car seat covers, made of non-elastic materials that are typically used in the manufacturing of baby blankets, are available wherein the cover is designed to fit over the opening of the car seat, sometimes with an elastic sown around the bottom hem of the cover so as to snugly mount the cover over the outer edges of the car seat. Other car seat covers, of which the applicant is aware, include covers manufactured of non-elastic materials, having some form of fastener for fastening the cover to the handle of the car seat or infant carrier or to other portions of the car seat or infant carrier, such fasteners including buttons, ties, zippers, snaps and similar fasteners. Although such covers may be used for covering a child in a car seat or infant carrier, they may not be used for other purposes such as covering the front of a stroller or the infant seat basket of a shopping cart, as these covers are not manufactured from material or sized so as to enable stretching of those covers over differently sized and shaped objects. Often, a caregiver may inconveniently carry multiple devices for different purposes; for example, a caregiver may have one or more car seat covers for use in different types of weather conditions, such as cold weather conditions as opposed to warm weather conditions, and a caregiver may additionally have separate covers for covering the opening of the stroller and yet another cover for covering the infant seat basket and handle of a shopping cart.

Other attempts to address the need for a cover to shield an infant or child from environmental elements in various different settings, of which the applicant is aware, include covers manufactured of a stretchable, elastic material, which may be used to cover a variety of differently sized and shaped open vessels. For example, such covers may be used as a car seat cover, a stroller cover and a breastfeeding cover. However, such covers are typically only suitable for warmer weather conditions, and do not for example provide much protection from cold, wind and precipitation in colder weather conditions. Furthermore, to the applicant's knowledge, such covers do not for example provide protection from bugs or insects that may cause a nuisance to the child during transport in a stroller, while at the same time allowing the child to see through the cover, caregivers will often have multiple different covers for each particular application. Furthermore, in the case of protection from insects while a child is riding in a stroller, to the applicant's knowledge, solutions presently available in the market are limited to covers which are typically manufactured to fit a particular configuration of stroller, such covers having various fastener elements to mount the screen cover to the particular stroller.

Thus, there is a need in the market for a multipurpose cover which may be used for shielding a child from various different environmental elements, and which may be used for multiple purposes, such as use in varying weather conditions and/or for various different applications in which shielding the child from environmental elements is desired.

### SUMMARY

As disclosed herein, an improved multipurpose cover is provided, the cover having a wholly resilient fabric body defining a cavity therein, the body having an exterior layer, extending from a lower end to an upper end, the exterior layer having an interior surface, the upper and lower ends defining upper and lower openings in the cavity respectively, the resilient body having a releasable fastener adapted to releasably close a third, vertically extending opening into the exterior layer in the cavity, wherein the body tapers so as to narrow in width from the lower end to the upper end, wherein the cover is adapted to be releasably mounted around and over a circumference of a container so as to at least partially cover an upper opening into the container defined by the circumference.

The cover may be mounted to an infant carrier, car seat, stroller, a rocking baby swing device (typically used indoors), shopping cart, high chair or similar vessel (herein collectively referred to as a container) so as to at least partially cover the opening of the container so as to shield a child positioned in a cavity of the container from environmental elements, such as wind, rain, snow, precipitation, smoke, dust, sunlight, insects, noise, or other environmental elements. The cover does not include any mounting elements or fasteners for mounting or fastening the cover to a container or other object. Rather, the cover is mounted to a container by stretching the lower opening of the body so as to fit around a frame of the container. For example, a frame of an infant carrier may include the perimeter of the seat bucket, the frame of a stroller may include the stroller frame and the handles of the stroller, for example in a foldable umbrella stroller. In addition to using the cover as a cover to shield the opening of a container, the cover may also be used to cover the infant seat basket and the handle of a shopping cart, for example to protect the child from germs on the shopping cart handle and other surfaces of the shopping cart, or in the case of a high chair, to protect the infant from dirt and germs on surfaces of the high chair, or in the case of a baby swing on a playground, to protect the child from germs and dirt that may be on the surface of the baby swing. In such applications the lower opening of the cover is stretched over the shopping cart handle and outer perimeter of the infant seat basket of the shopping cart, or in the case of a highchair or baby swing, over the outer perimeter of the high chair or baby swing. The cover may also be used as a breastfeeding cover so as to shield a mother's breast and a breastfeeding child from public view, wherein the cover is mounted over the shoulders and torso of a breastfeeding mother and the head and body of a breastfeeding child by sliding the mother's head and torso and the body of the baby through the bottom opening of the cover and the mother's head through the upper opening of the cover. The cover may additionally be mounted around the neck of a mother by sliding the mother's head through the upper and lower openings of the cover such that the cover may be worn as an infinity scarf fashion accessory. The cover may additionally be used as a blanket or towel. Furthermore, the cover advantageously protects the back of a vehicle's seat from marks from a child's shoes, resulting from kicks against the seat.

In some embodiments of the present disclosure, the interior surface of the cover may comprise wholly or partially of an insulating layer of fabric. For some embodiments in which the interior surface is partially comprised of the second insulating layer of fabric (so as to be comprised of a double layer of fabric) and partially comprised of the exterior layer of fabric (so as to have a single layer of fabric only), the body will include an insulating portion having two layers of fabric (both the exterior and insulating layers) and a portion having one layer of fabric (the exterior layer only). The use of such embodiments of the cover, having reversible orientations when used as a cover, may be selectively adapted to suit either warm or cold weather conditions, whereby the portion of the body having both the insulating and exterior layers of fabric may be oriented so as to span across the opening of an infant carrier or other vessel in colder weather, or the orientation may be reversed such that the portion of the body having only the exterior layer of fabric spans across the opening of an infant carrier or other vessel in warmer weather. For other embodiments in which the interior surface wholly comprises the second insulating layer of fabric, the cover may be particularly useful for cold weather and/or winter weather, as the entire body of the cover includes both the first exterior layer of fabric and the second insulating layer of fabric.

In some embodiments of the present disclosure, the cover may include a resilient mesh layer located within the cavity of the body. The mesh layer is attached to one portion or half of the interior surface, along a first side edge and shoulder and a second opposite side edge and shoulder. The mesh layer is not attached to the edges of the upper opening or lower opening. When mounted to a container, the mesh layer and exterior layer may be oriented to cover the opening of the container. The mesh layer is concealed by the exterior layer when the releasable fastener is in a closed position. When additional air flow and ventilation is required, the releasable fastener may be opened fully or partially, the resilient tension in the cover spreading open the mesh panel as the fastener is undone.

In other embodiments of the present disclosure, the exterior layer of the cover may comprise of fabric that is a mesh fabric which is elastic and has a loose weave so as to create gaps between the threads of the exterior layer of fabric, and the interior surface is partially comprised of a second layer of fabric which is elastic and breathable, whereby the body of the cover has a mesh portion comprising only one layer of the mesh fabric, and a sun blocking portion having both the mesh layer of fabric and the second layer of fabric that is non-mesh, elastic and breathable. Optionally, other embodiments may have a sun blocking portion that consists only a single layer of fabric, being the elastic non-mesh breathable fabric. Such embodiments may be particularly useful for warmer weather whereby the cover may be oriented so as to cause the mesh portion to cover the opening of an infant carrier or other vessel when it is desired to allow the infant or child to see through the cover while still protecting the infant or child from insects and partially blocking the sun or other light, and the cover may be oriented in an opposite direction so as to cause the sun blocking portion to cover the opening of the infant carrier or other vessel when it is desired to shield the infant or child from the sun and to shield the child from public view.

Some embodiments of the present disclosure may include one or more pockets positioned on the exterior layer of the cover. Preferably, the one or more pockets may be positioned whereby a bottom of the pocket is proximate to the lower opening of the cover and positioned such that a width of the pocket body spans partially across both the portion having two layers of fabric and the portion having one layer of fabric (for such embodiments having that structure), such that the pocket may be conveniently located at the side of the infant carrier or car seat proximate to the base of the car seat when the cover is mounted to an infant carrier or similar vessel, and when used for other applications, the pocket may similarly be located at the side of the device on which the cover is being used, such as having a pocket at the side of an infant seat basket of a shopping cart, at the side of a high chair or at the side of a baby swing at the playground. The pocket may be used to store small items, such as keys, baby toys or baby accessories. The pocket may conveniently be also used for storage of the cover when the cover is not in use, by inverting the pocket and stuffing the body of the cover into the pocket. Preferably, the pocket may be affixed to the exterior surface of the cover by sewing or other means such that the stitches or other attachment means are not visible when viewing the pocket when the pocket is positioned on the exterior surface of the cover and when the pocket is inverted so as to store the cover within the pocket.

### BRIEF DESCRIPTION OF THE DRAWINGS

FIG. 1 is a side elevation view of an infant carrier seat to which a cover may be mounted.

FIG. 2 is a side perspective view of an umbrella stroller to which a cover may be mounted.

FIG. 3 is a side elevation view of an embodiment of the cover in accordance with the present disclosure mounted to the infant carrier seat illustrated in FIG. 1.

FIG. 4 is a front elevation view of the embodiment of the cover illustrated in FIG. 3.

FIG. 5 is a laid flat view of an embodiment of the cover in accordance with the present disclosure.

FIG. 6 is a laid flat view of an embodiment of the cover in which the cover has been opened along the seams to expose the interior surface of the cover, in accordance with the present disclosure.

FIG. 6A is a cross-sectional view of the embodiment illustrated in FIG. 6, taken along line 6A-6A.

FIG. 7 is a laid flat view of an embodiment of the cover in which the cover has been opened along the seams to expose the interior surface of the cover, in accordance with the present disclosure.

FIG. 7A is a cross-sectional view of the embodiment illustrated in FIG. 7, taken along line 7A-7A.

FIG. 8 is a laid flat view of an embodiment of the cover in which the cover has been opened along the seams to expose the interior surface of the cover, in accordance with the present disclosure.

FIG. 8A is a cross-sectional view of the embodiment illustrated in FIG. 8, taken along line 8A-8A.

FIG. 9 is a laid flat view of an embodiment of the cover in which the cover has been opened along the seams to expose the interior surface of the cover, in accordance with the present disclosure.

FIG. 9A is a cross-sectional view of the embodiment illustrated in FIG. 9, taken along line 9A-9A.

FIG. 10 is a side perspective view of the embodiment illustrated in FIG. 3, wherein the cover is mounted to a seating structure having a frame.

FIG. 11 is a front view of the embodiment illustrated in FIG. 3, wherein the cover is worn by a breastfeeding mother.

FIG. 12 is a front view of an embodiment of the cover in accordance with the present disclosure, in which the cover is stowed into the inverted pocket.

FIG. 13A is a front elevation view of an embodiment of the cover in accordance with the present disclosure, in which the cover includes a two way zipper, fully closed.

FIG. 13B is a front elevation view of an embodiment of the cover in accordance with the present disclosure, in which the cover includes a two way zipper, partially opened.

FIG. 13C is a front elevation view of an embodiment of the cover in accordance with the present disclosure, in which the cover includes a two way zipper, partially opened.

FIG. 14 is a laid flat view of the embodiment of the cover illustrated in FIGS. 13A, 13B, and 13C, in which the cover has been opened along the seams to expose the interior surface of the cover, in accordance with the present disclosure.

FIG. 15A is a rear view of the embodiment illustrated in FIGS. 13A, 13B, and 13C wherein the cover is worn by to a breastfeeding mother, the zipper closed.

FIG. 15B is a rear view of the embodiment illustrated in FIGS. 13A, 13B, and 13C wherein the cover is worn by to a breastfeeding mother, the zipper fully opened.

FIG. 16 is a front elevation view of an embodiment of the cover in accordance with the present disclosure mounted to the infant carrier seat illustrated in FIG. 1.

### DETAILED DESCRIPTION

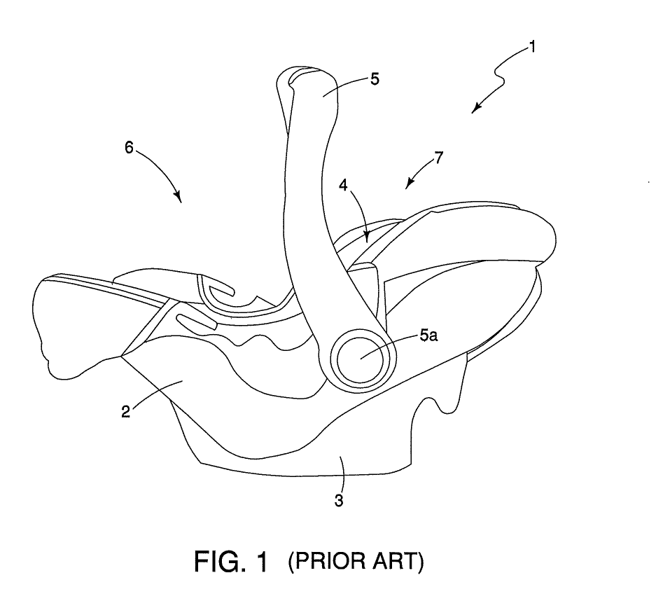

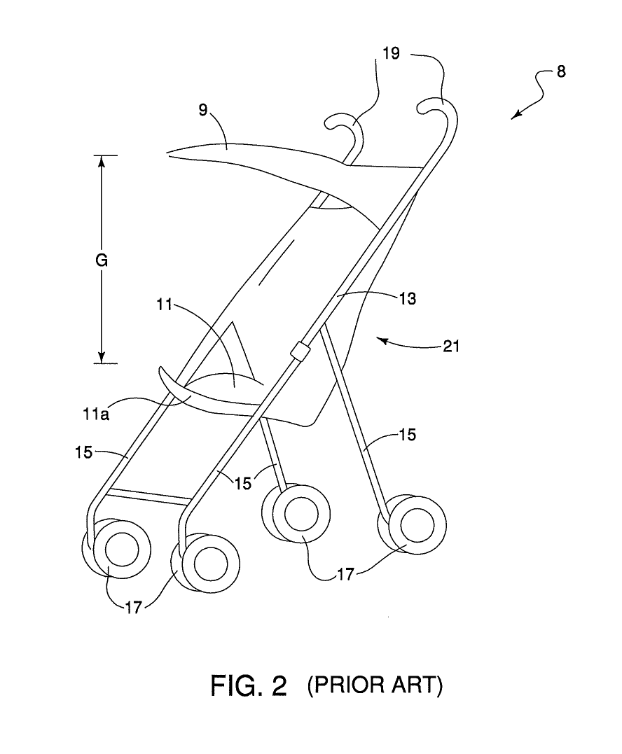

With reference to FIGS. 1 and 2, examples of the environment in which the multipurpose cover 10 disclosed herein may be used are provided so as to better illustrate some examples of the various uses for the multipurpose cover 10. FIG. 1 illustrates the infant carrier 1, also commonly referred to as a child seat or a car seat, which is designed for carrying a child to and from a motorized vehicle and also for securing the child in the motorized vehicle during travel. As defined above, the infant carrier is intended to fall within the definition of “container” as used herein. The infant carrier 1 typically includes a bucket seat shell 2 supported on a base 3, the bucket seat shell 2 defining a seat cavity 4 into which the child may be placed. Carrier 1 also includes a handle 5 pivotally attached to the bucket seat shell 2 at either end 5a of the handle 5 such that the handle 5 arches over the main opening 6 of the carrier 1.

FIG. 2 illustrates a typical umbrella stroller 8 commonly known in the art. A typical umbrella stroller 8 includes a foldable frame 13 supporting a seat 11 having a seat edge 11a, the seat 11 suitable for supporting a child in the stroller 8. Strollers 8 also have legs 15 connecting the frame 11 to wheels 17, and handles 19 for the caregiver to hold onto when pushing the stroller 8. Some umbrella strollers 8 may also include a canopy 9 providing shade from the sun over the head of the child when the child is seated in the stroller 8 by partially blocking rays of light from the sun directed towards the stroller 8. Carrier 1 illustrated in FIG. 1 and stroller 8 illustrated in FIG. 2 are merely examples of the type of containers on which the multipurpose cover 10 described herein may be releasably mounted, to shield a child seated in the container from environmental elements. Other examples may include: baby swings (on the playground), rocking baby swing devices (typically used for soothing young babies when indoors), infant seat baskets on shopping carts typically found in grocery and other retail stores, baby carriers, high chairs, bassinets, and other containers or structures that have a cavity into which a child may be placed and an opening through which environmental elements may pass through to make contact with or otherwise impact the child, and or surfaces that may have dirt and germs that the child or baby may come into contact with (again, collectively herein containers).

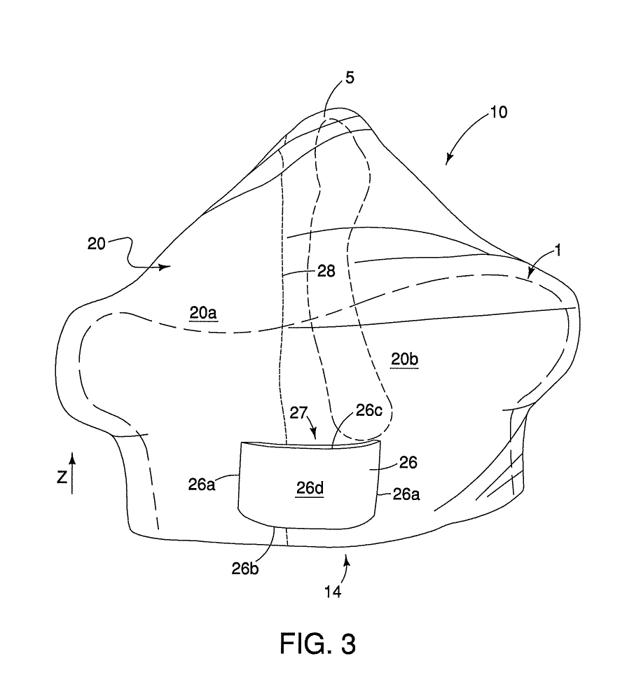

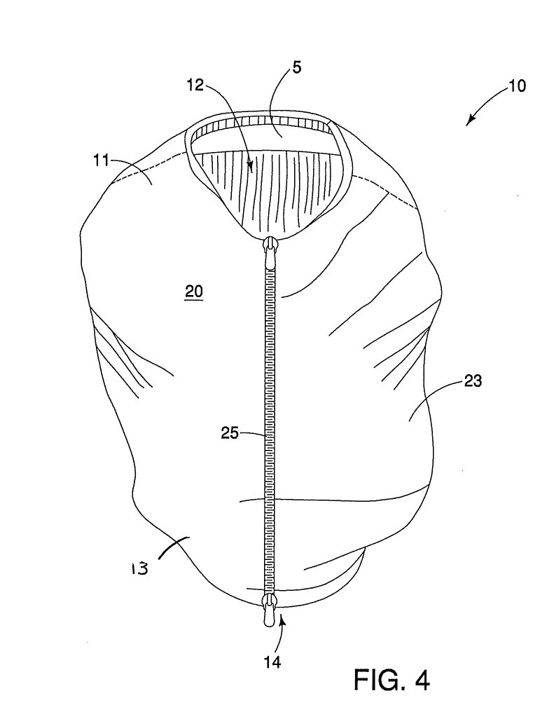

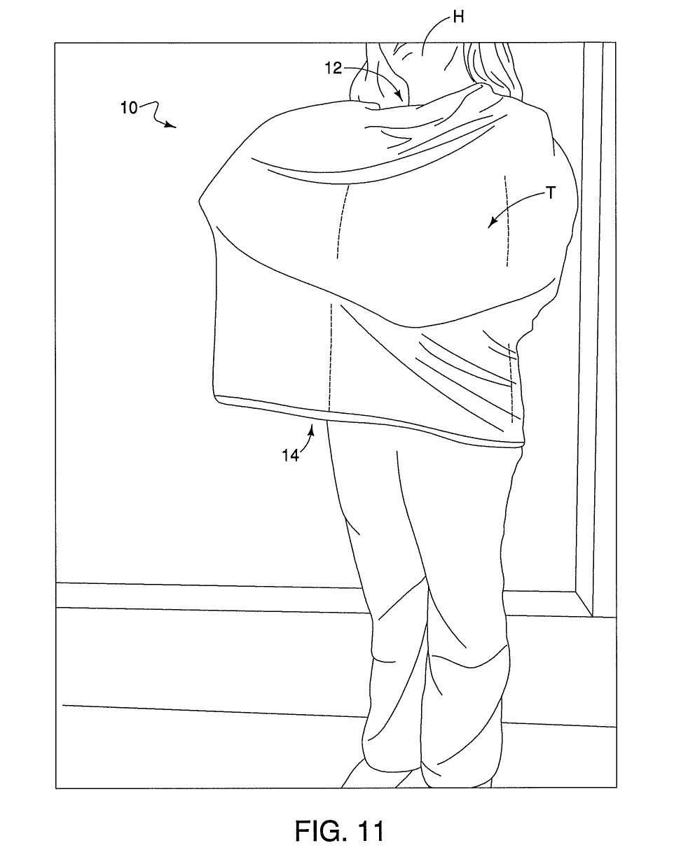

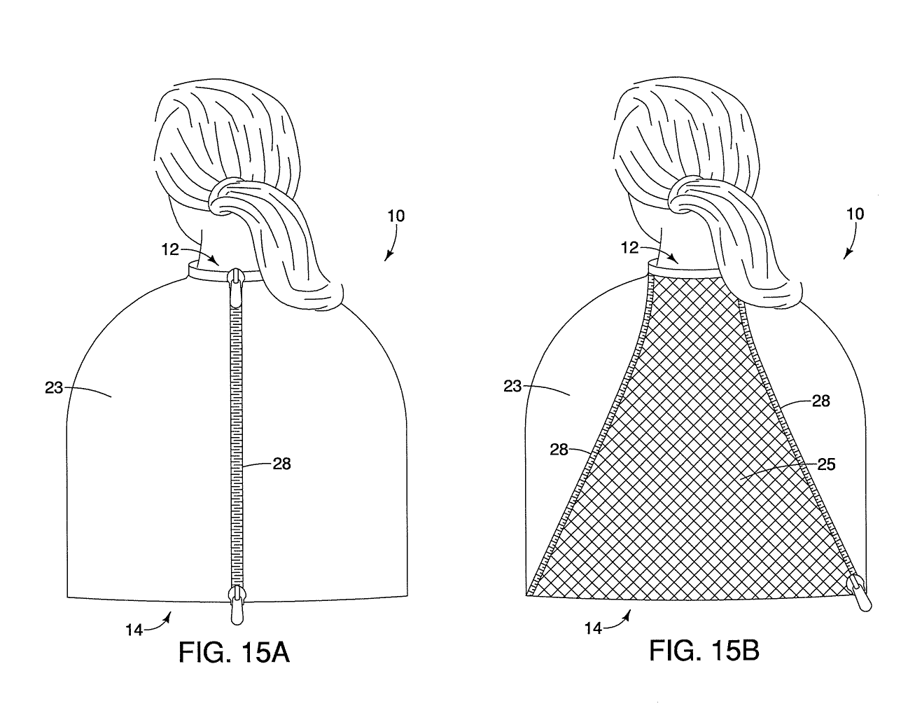

Now referring to FIGS. 3 through 16, the applicant will describe embodiments of the multipurpose cover 10 in accordance with the present disclosure. FIG. 3 Illustrates an embodiment of a multipurpose cover 10 mounted over a carrier 1, such as the infant carrier illustrated in FIG. 1. As may be viewed for example in FIGS. 4 and 5, a multipurpose cover 10 is approximately tubular, although preferably slightly conical or frusto-conical in shape, and includes an upper end 11 and upper opening 12, a lower end 13 and lower opening 14. A plan view of one half of the exterior side panel or surface 20 of the cover 10 includes two side edges 16, 18 (seen in FIG. 5). The oppositely disposed side edges 16, 18 may each include corresponding shoulders 16a, 18a. IN the preferred embodiment, the body of cover 10 gradually narrows from the shoulders 16a, 18a upwardly towards the upper end 11.

Furthermore, the width A of the lower opening 14 may be preferably greater than the width B of the upper opening 12 so as to provide a preferred shape of the cover when in use for example as a breast-feeding cover, such that the mother's shoulders are positioned inside the cover 10 approximately adjacent to the shoulders 16a, 18a of the cover 10 when the mother is inside the cavity of the cover 10. A further advantage of the width A of lower opening 14 being greater than the width B of upper opening 12 is that when the cover 10 is mounted on a container, such as an infant carrier 1 or stroller 8, the cover 10 provides a better resilient fit over the container opening, such as the main opening 6 of carrier 1, when mounted therearound, and the taper towards the smaller upper opening 12 fits over the back supporting structure and closes effectively over the container opening. This also provides for tensioning of the fabric across the container opening, inhibiting inwardly hanging fabric that might interfere with the child, and allowing the convenient use of a releasable fastener on the cover 10 along the length of the container opening. One example of such a releasable fastener is a zipper. As the zipper is undone the tension in the resilient cover parts the releasable fastener, allowing ventilation, for example through the mesh layer 25. For example, as illustrated in FIG. 4, such a configuration of the cover 10 allows for only a portion of handle 5 and a small portion of main opening 6 of the carrier 1 to be exposed through upper opening 12 when the cover 10 is mounted to carrier 1, conveniently providing access to handle 5 for transporting the carrier 1 while leaving most of the main opening 6 covered by the cover 10.

The body of the cover 10 comprises an exterior layer 23 having an exterior surface 20 and interior surface 22a, 22b. The exterior layer 23 may be comprised of a flexible cloth, fabric or similar material that is elastic, i.e. resilient in at least one direction (for example, laterally), so as to permit multiple uses of the cover 10. Preferably, the exterior layer 23 is manufactured of a fabric or other material that feels soft against the skin, is lightweight and drapes in an attractive manner when worn as an accessory (for example, as an infinity scarf), is simple to care for in that it is machine washable and is durable. For example, without intending to be limiting, the applicant utilizes a fabric comprising 75% polyester, 20% rayon and 5% Spandex™ to manufacture the exterior layer 23 of the cover 10, which exterior layer 23 possesses the above properties preferred for an exterior layer 23. As used herein, Spandex™ (otherwise also known as Lycra™ or elastane) is intended to refer to synthetic fibres having a minimum of 85% polyurethane polymer content or functional equivalent thereof.

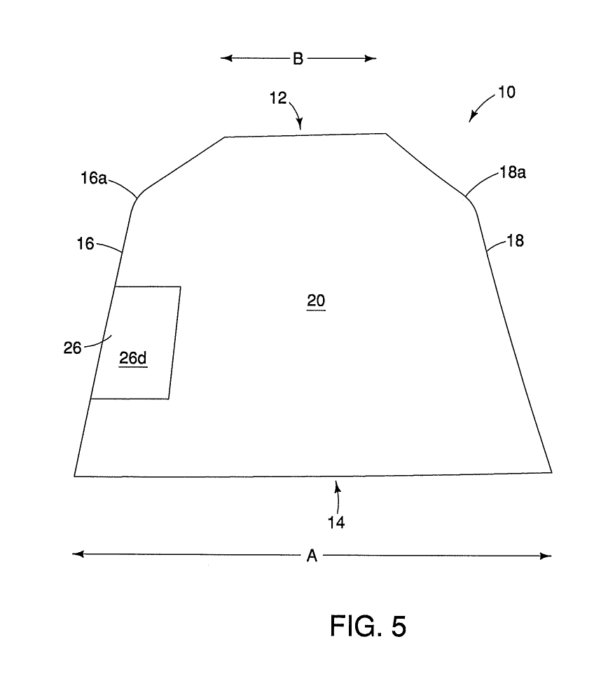

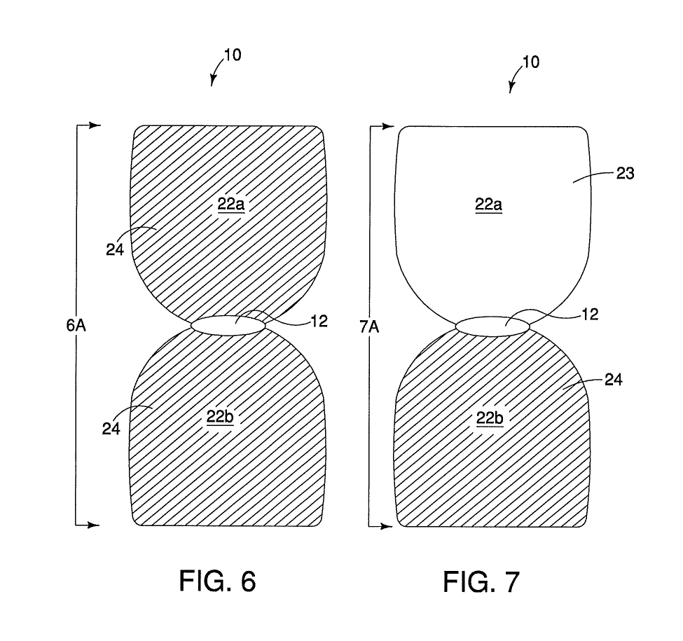

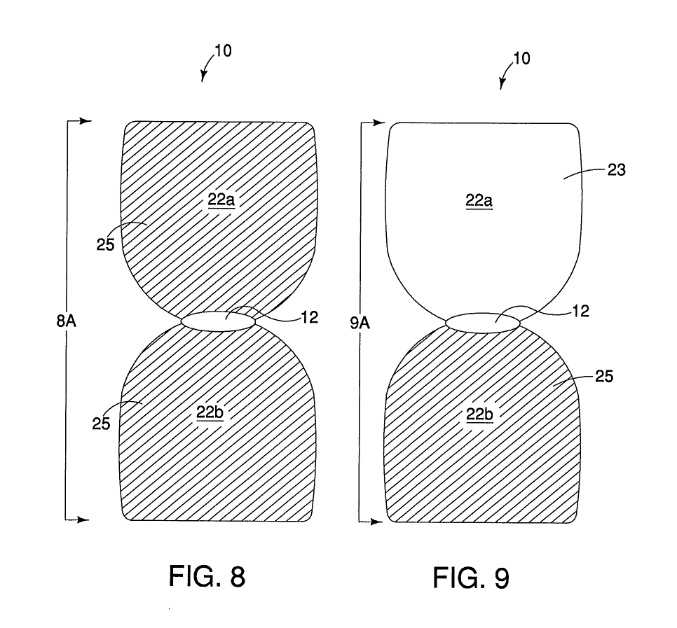

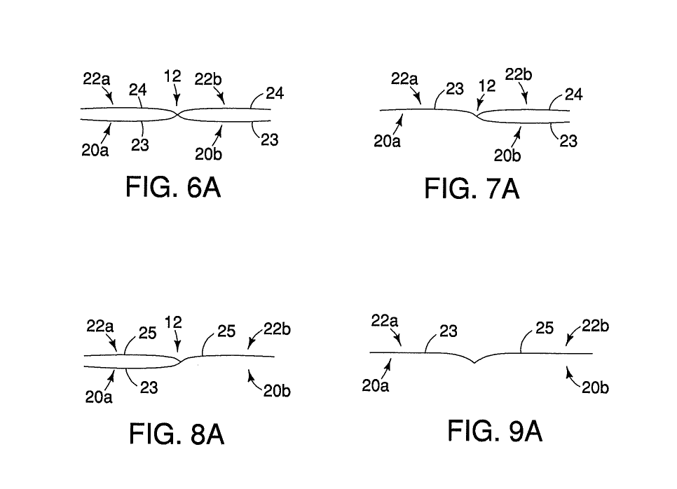

As shown in FIGS. 6, 6A, 7 and 7A, either one or both of the portions or halves of the interior surface 22a, 22b may include a second, insulating layer 24 of fabric, cloth, or other material that is flexible, breathable, and elastic. The elasticity of the insulating layer 24, for example stretchy fleece, maintains the multipurpose function of the cover 10. The insulating layer 24 provides insulation against the cold weather, and may also assist with reducing or preventing wind or precipitation from passing through the body of the cover 10, for example when the cover is being used outdoors during transportation. For example, without intending to be limiting, the applicant utilizes a fabric, commonly referred to as a “minky” type of fleece fabric, comprising 95% polyester and 5% Spandex™ to manufacture the insulating layer 24 of cover 10, which fabric possesses the above properties preferred for an insulating layer 24.

The second insulating layer 24 may be included on both halves or panels of the interior surface 22a, 22b of the cover 10, as shown in FIGS. 6 and 6A, which is particularly helpful in colder climates or for winter weather. Herein, the applicant may refer to the embodiment shown in FIGS. 6 and 6A as a winter cover, as having the second insulating layer 24 on both halves or panels 22a, 22b of the interior surface of cover 10 may be particularly useful in cold winter weather. However, the term “winter cover” is not intended to be limiting and could also be referred to as a cold weather cover. It will be appreciated by a person skilled in the art that the winter cover embodiment may be used in cold weather, regardless of the season.

In an alternative embodiment, as shown in FIG. 7, the first half 22a of the interior surface may include only the exterior layer 23, while the second half of the interior surface 22b may include the insulating layer 24. Advantageously, the embodiment illustrated in FIG. 7 may be used for varying weather conditions, including both cold and warm weather conditions, and may be referred to generally herein as an all season embodiment of the cover 10, whereby the cover 10 is reversible and may be selectively oriented on an infant carrier 1 or other container depending on the weather conditions. For example, the cover 10 may be oriented on an infant carrier 1 such that the interior surface 22b including the second insulating layer 24 as well as a portion of the exterior layer 23 corresponding to the portion 20b of exterior surface 20 may cover the main opening 6 of the carrier 1, thereby covering main opening 6 of carrier 1 with two layers of cloth including both the insulating layer 24 and exterior layer 23, thereby providing additional warmth and shielding from environmental elements. In such an orientation, the interior surface 22a of the cover 10, comprising only a single layer of fabric or cloth namely exterior layer 23, may be oriented so as to cover the canopy opening 7 of the carrier 1, which is less exposed to the weather elements during transport of the carrier 1. In warmer weather conditions, where the cover 10 is used primarily to provide privacy for the child and/or to block the sun, the reverse orientation whereby the interior surface 22a including only the exterior layer 23 extends over the main opening 6 of carrier 1, and the interior surface 22b including the insulating second layer 24 extends over the canopy opening 7 of the carrier 1, such that more air is allowed to pass through the first half 22a of the cover 10 through the greater main opening 6 of the carrier 1 thereby keeping the child more cool in warmer weather. By reverse orientation the applicant means that the cover may be reversed end-for-end for example.

Similarly, the reversible orientations of the all season embodiment of cover 10, illustrated in FIGS. 7 and 7A, may be utilized when mounting the cover 10 to other containers, such as baby strollers, whereby the handles 19 and frame 13 of the stroller 8 are inserted through the bottom opening 14 and upper opening 12 of the cover 10 and oriented such that the first half 22a, comprising only the exterior layer 23, may be positioned over the rear 21 of stroller 8 and the second half 22b, comprising the insulating layer 22b, may be positioned over the gap G between the stroller canopy 9 and the edge of the stroller seat 11a. The applicant further notes that either the winter cover embodiment or all season embodiment of cover 10, illustrated respectively in FIGS. 6, 6A, 7 and 7A, may, in addition to being useful for covering an infant carrier 1 or similar container in cold weather, be particularly useful as a breastfeeding cover for situations where a mother is breastfeeding an infant outdoors in cold weather. Another use for either the winter or all season embodiments of cover 10 is as an extra layer of warmth that may be worn over both the torso T of the mother and an infant carried on the mother's chest in an infant carrier device, for example when the mother wishes to take the infant for a walk in an infant carrier worn by the mother (or caretaker) in cold weather. In such situations, as most cold weather coats for adults are not typically sized so as to fit over both the caretaker and the infant in an infant carrier worn by the caretaker, the cover 10 would usefully provide an additional layer of warmth without interfering with the caretaker's ability to also wear a cold weather coat.

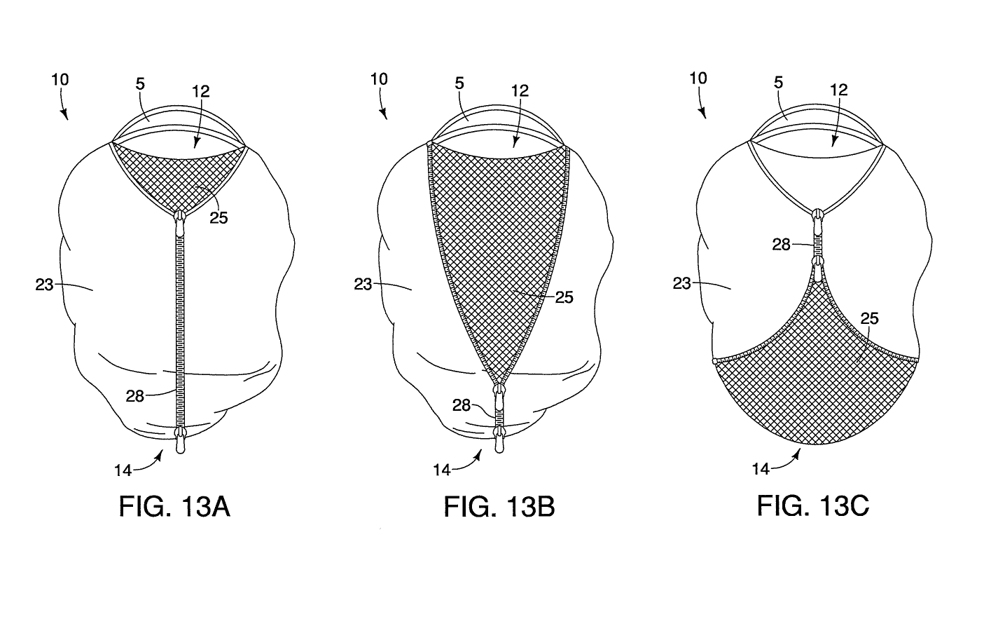

The cover 10 includes a releasable fastener, such as a hook, button, Velcro™ strip, hook and lop fastener, or zipper, installed to the exterior layer 23. The fastener would typically releasably close a gap in the cover which runs from the lower opening 14 to the upper opening 12. Opening the releasable fastener provides quick and easy access to a child I in a container or the like, in addition to increased air flow and ventilation for the child I in the carrier. For example, and without intending to be limiting, the cover 10 may include a two-way zipper 28, as shown in FIGS. 13A, 13B, and 13C. As seen in FIGS. 13A, 13B, and 13C, the two-way zipper 28 may be released partially or fully in either direction A or direction B. The zipper 28 allows a caregiver to expose more of the main opening 6 of the carrier 1 if the infant requires more air flow.

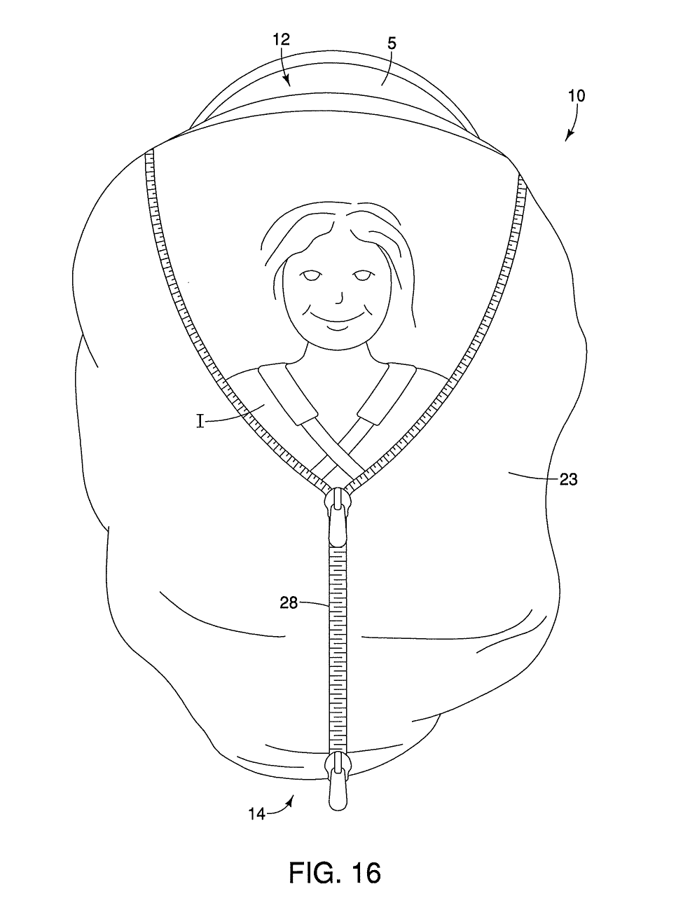

As discussed above, the use of winter jackets and and/or snowsuits while an infant or child is seated in a carrier 1 and being transported in a vehicle is no longer recommended. Applicant believes that bulky, for example padded, fabric between a child and the infant carrier straps can allow the straps to come loose during an accident, putting the child at risk of injuries and/or ejection from the carrier 1. The winter cover is an alternative option for keeping the child warm and firmly strapped in while being transported in a vehicle. As illustrated in FIG. 16, the cover 10 may be mounted to the carrier 1 without impacting use of or access to the carrier straps, and the releasable fastener 28 may be opened so as to expose the child's face, while still protecting the child from the cold.

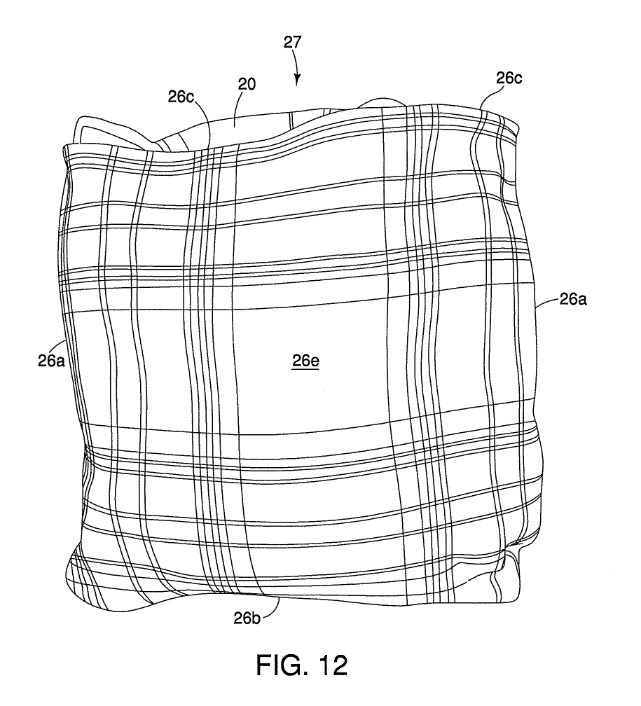

It will be appreciated by a person skilled in the art that the various embodiments of the cover 10 disclosed herein are manufactured with a combination of exterior layer 23 and insulating layer 24 each made of fabrics that are elastic and thereby capable of stretching so as to fit the perimeter or circumference of the lower opening 14 of the cover 10 over or around various differently sized and shaped objects, such as containers defined herein, people or surfaces, such as around the perimeter of the bucket seat shell 3 of an infant carrier 1, or over a mother's torso T and breast and the body of a breastfeeding infant (as illustrated for example in FIG. 12), or over the frame 13 and handles 19 of an umbrella stroller 8, and also resiliently returning to the original, un-stretched shape and width A of lower opening 14 when the cover 10 is not in use, or when being used for example as an infinity scarf or similar fashion accessory. In particular, to promote the multiple uses of the cover 10, including for example as a scarf or fashion accessory to be worn around the neck, the cover 10 advantageously does not feature any attachment members or clasps, ties, fasteners or the like for attaching the cover 10 to a container, such as strollers 8, carriers 1 or shopping cart infant seats, as the inclusion of any such attachment members or clasps, ties, fasteners or the like may cause the cover 10 to become bulky and to not drape as well or be as aesthetically pleasing when worn as a scarf.

In other embodiments of the present disclosure, such as those illustrated for example in FIGS. 8, 8A, 9 and 9A, either one or both of the halves or portions of the interior surface 22a, 22b may comprise of a mesh layer 25, mesh layer 25 being manufactured of a cloth, fabric or similarly flexible material that is elastic and loosely woven so as to provide a mesh or screen-like fabric or cloth, which is capable of allowing increased amounts of air to pass through the fabric (as compared to the fabrics used for the exterior layer 23 of any of the embodiments described herein or the insulating layer 24 of the winter or all season embodiments described herein) and which is also capable of partially or fully blocking light and/or insects. For example in the embodiment shown in FIGS. 8 and 8A, both halves or portions 22a, 22b of the interior surface comprise the mesh layer 25, and the corresponding exterior surface portion 20a comprises a second, exterior layer 23, while the exterior surface portion 20b only comprises the same mesh layer 25. In the embodiment illustrated in FIGS. 9 and 9A, the interior surface portion 22b is comprised of a mesh layer 25 and the corresponding exterior surface portion 20b is also only comprised of the same mesh layer 25, while the interior surface portion 22a is comprised of the exterior layer 23 and the corresponding exterior surface 20a is also only comprised of the same exterior layer 23. The embodiments illustrated in FIGS. 8, 8A, 9 and 9A each utilize a fabric, cloth or similar material for exterior layer 23 that is, as described above with reference to the embodiments shown in FIGS. 6 and 7, elastic and breathable, but in which the threads or fibers of the fabric are more tightly woven so as to not create a mesh.

The embodiments shown in FIGS. 8 and 9 may be particularly useful for warmer weather conditions where it is desired to shield a child or infant from insects while allowing the infant to see through the cover 10, and the same cover 10 may be optionally utilized so as to block sunlight or provide privacy to the child by orienting the reversible cover 10 in another direction. For example, the portion of the cover comprising interior surface 22a and corresponding exterior surface 20a, in both of the embodiments shown in FIGS. 8 and 9, include an exterior layer 23 which as described above is a more tightly woven fabric that is not a mesh and which is more effective at blocking light and providing privacy, while the portion of the cover comprising interior surface 22b and corresponding exterior surface 20b, in both of the embodiments shown in FIGS. 8 and 9, are each comprised of a single layer of mesh fabric 25 which is a loosely woven fabric allowing greater passage of light, and which may be seen through more easily. Where it is desired to use the cover 10 as a partial shield against light and/or insects while allowing the child to see through the cover 10, the section of the cover 10 corresponding to the single mesh layer 25 for exterior and interior surface portions 20b, 22b may be oriented so as to cover the main opening 6 of a baby carrier 1 or the gap G of a stroller 8, for example. And on the other hand, where greater shielding from light and/or insects is desired and/or where privacy for the child is desired, the cover 10 may be selectively oriented so as to cause the section of the cover corresponding to the double layer including a mesh layer 25 and an exterior layer 23 for interior and exterior surface portions 22a, 20a (in the FIG. 8 embodiment) or comprising a single exterior layer 23 for interior and exterior surface portions 22b, 20b (in the FIG. 9 embodiment) to cover the main opening 6 of an infant carrier 1 or a gap G of a stroller 8.

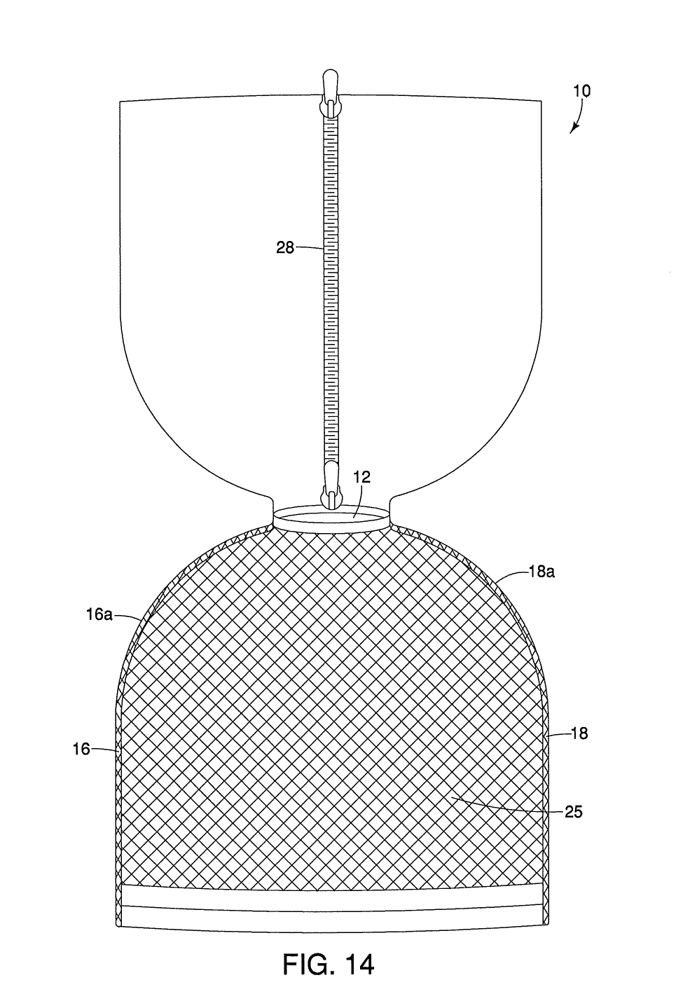

With reference in particular to FIGS. 13A, 13B, and 13C, an alternative embodiment of the present disclosure is disclosed, which herein the applicant may refer to as a summer cover. The summer cover may be useful for warmer weather conditions, and for shielding a child from insects and ultraviolet radiation. The term “summer cover” is not intended to be limiting and it will be appreciated by a person skilled in the art that the summer cover embodiment may be used in any warm weather, regardless of the season. The summer cover includes a mesh layer 25 attached along edges 16 and 18, and shoulders 16a and 18a, as illustrated in FIG. 14. The mesh layer 25 may be attached to either interior surface 22a or 22b. The exterior layer 23 of the cover is manufactured of a fabric that is lightweight, breathable, and elastic. For example, without intending to be limiting, the applicant utilizes a bamboo rayon, cotton blend with Spandex™. The exterior layer 23 and mesh layer 25 provide protection from ultraviolet radiation, which is especially important for young infants, as sunscreen is not recommended in children less than 6 months of age. The cover 10 includes a releasable fastener to close a third vertical opening in the cover 10, such as those described above. The cover 10, as illustrated in 13A, 13B, and 13C, which includes a two-way zipper 28, may be mounted to an infant carrier 1, the mesh layer 25 oriented so as to cover the opening 6 of the carrier 1. The zipper 28, when in a closed position, conceals the mesh layer 25 within the cavity of the cover 10 and shields a child or infant from the sun, insects, and public view, as shown in FIG. 13A. Alternatively, the zipper 28 may be partially or fully open, exposing portions of the mesh layer 25 and allowing greater airflow and light to pass through the cover 10. The mesh layer 25, when exposed, is capable of partially or fully blocking sunlight and/or insects. When the mesh layer 25 is not required, the cover 10 may be selectively oriented so as to cause the mesh layer 25 to be positioned at the rear of the bucket seat shell 2, so that only the exterior layer 23 and zipper 28 cover the opening 6 of the carrier 1. As described above, because the cover is resilient, and fits snugly over the sides of and around the opening of various containers in which a child is carried or seated, the cover is in tension over the opening which then spreads open the mesh panel 25 as the zipper 28 is undone.

The summer cover may be used as a breastfeeding cover in warm weather so as to shield a mother's breast and a breastfeeding baby from public view, wherein the cover is mounted over the shoulders and torso of a breastfeeding mother and the head and body of a breastfeeding child by sliding the mother's head and torso and the body of the child through the lower opening of the cover and the mother's head through the upper opening of the cover. With reference to 15B, the zipper 28 may be partially or fully open, the mesh layer 25 selectively oriented so as to cover the mother's back, while the exterior layer 23 shields the breastfeeding baby and the mother's breast. This orientation allows greater air flow for the mother and child while breastfeeding in warmer climates.

With reference in particular to FIGS. 3, 10 and 12, in some embodiments of the present disclosure the cover 10 may include a pocket 26 secured to the exterior surface 20 of the cover 10. Preferably, the pocket 26 may be positioned on the exterior surface 20 so as to be positioned across a junction or seam 28 between the halves or portions 20a, 20b, of the exterior surface 20, and proximate to the lower opening 14 of the cover 10. The pocket 26 may comprise side edges 26a, 26a and a bottom edge 26b, wherein each of the edges 26a, 26a and 26b are secured so as to span across seam 28. Means for securing the pocket 26 to exterior surface 20 may include for example, without intending to be limiting: stitching, gluing, heat fusion, or any other means known to a person skilled in the art. Preferably, the edges 26a, 26a, 26b of the pocket 26 may be secured to the exterior surface 20a, 20b, of the cover 10 in such a manner so as to not produce any visible seams when viewing the pocket 26 from the outside or from the inside of the pocket 26 for reasons that will be further explained below. Additionally, the pocket 26 may be made of a double layer of the same material utilized for the exterior layer 23 of cover 10, such as by forming the pocket 26 from a folded piece of cloth or fabric or forming the pocket 26 from two pieces of the material that are sewn such that the patterned side of the cloth or fabric is exposed on both the exterior surface 26d as well as the interior surface 26e of pocket 26, again for reasons that will be further explained below. However it will be appreciated by a person skilled in the art that the pocket 26 may be secured to the exterior surface 20a, 20b, with visible seams or visible stitches or other visible attachment means, and may be formed of a single layer of the same material utilized to form the exterior layer 23 of cover 10, and that such embodiments are intended to be included within the scope of the present disclosure.

The pocket 26 further has a free edge 26c that is not secured to the exterior surface 20a, 20b, and thereby forms pocket opening 27. Conveniently, when mounted to an infant carrier 1, the pocket 26 is oriented in such a way that the pocket opening 27 is oriented vertically in direction Z towards the handle 5 of the infant carrier 1, thereby providing easily accessible pocket cavity into which various articles may be stored when the cover 10 is in use, such as accessories for baby care including soothers wipes and similar accessories, in addition to keys, cell phones or other items that the baby's caregiver may wish to have handy and accessible during travel.

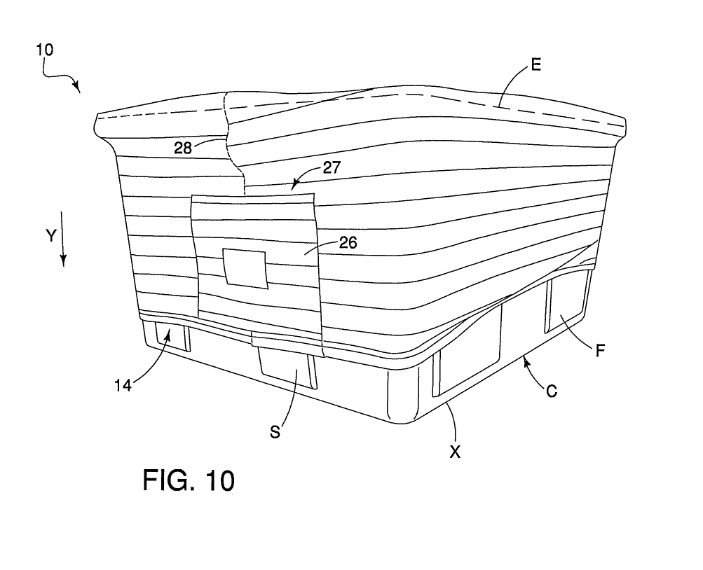

Advantageously, positioning the pocket 26 on the exterior surface 20 of cover 10 so as to be proximate to the bottom opening 14 ensures that the pocket 26 is located conveniently at the side of the carrier 1 when used to cover the carrier 1, where the pocket 26 is easily accessible for storing items without weighing down the cover 10 so as to cause the cover 10 to cave in through the main opening 6 (for example). Additionally, this provides for an ideal positioning of pocket 26 when the cover 10 is put to other uses. As illustrated in FIG. 10, cover 10 is mounted to a container-like vessel C, as an illustration of how the cover 10 may mount to various types of container-like vessel seats, typical examples of which include, without intending to be limiting: the infant seat basket of a shopping cart, a high chair or a baby swing at a playground, wherein such container-like vessel seats C may have an upper edge E over which the cover 10 is mounted by pulling the lower opening 14 over the upper edge E of seat C and pulled downwardly in direction Y until opening 14 is proximate the lower end X of container-like vessel seat C. Seat C further includes a front F and sides S, as shown in FIG. 10. In such circumstances, the caregiver may wish to protect the infant or child seated within the container-like vessel seat C to be protected from dirt, germs, liquids, food and other environmental elements that may be on the surfaces of such container-like vessel seats accessible to the infant or child.

When any of the embodiments of the cover 10 which include at least one double layer of material, such as the embodiments illustrated for example in FIGS. 6A, 7A and 8A, is used to cover the infant-accessible surfaces of a container-like vessel seat C, such as those described above, advantageously the portion of the cover 10 having two layers of fabric, cloth or material may provide an additional barrier between the child or infant and the dirt, germs, liquids, food or other environmental elements that may be on the surfaces of the container-like vessel seat C when those double-layer portions of cover 10 are partially or fully covering those surfaces.

As shown in FIG. 10, when the cover 10 is mounted to seat C, such as a playground baby swing, high chair, infant seat basket of a shopping cart, or the like, pocket 26 may be conveniently located at the side S of the container, with the opening 27 of pocket 26 readily accessible for depositing items such as utensils or face cloths (for example when used on a high chair), or soothers, small toys, wipes or other baby accessories, or keys, cell phones or other accessories of the caretaker (for example when used on a baby swing or infant seat basket of a shopping cart). The remainder of the cover 10 is draped within the cavity of the container, and the child's legs and waist may optionally be inserted through the upper opening 12 (not shown) of cover 10 when sitting in the container C. While this may be a preferred positioning of pocket 26 on the exterior surface 20 of cover 10, it will be appreciated by a person skilled in the art that the pocket 26 may be positioned elsewhere on the cover 10 and such embodiments are intended to be within the scope of the present disclosure.

When it comes time to store the cover 10, the body of the cover 10 may be conveniently folded or stuffed into the pocket 26 by inverting the pocket 26 or in other words, turning the pocket inside out and stuffing the entire cover 10 into the inverted pocket 26. Advantageously, for embodiments in which pocket 26 is attached to the exterior surface 20 by means that are not visible, the pocket 26, when inverted for storing the cover 10, the seams or other attachment means for attaching the pocket 26 to exterior surface 20 of cover 10 will not be visible and will thus be more aesthetically pleasing as compared to a pocket 26 having visible seams between the pocket 26 and exterior surface 20, as shown for example in FIG. 12. Furthermore, for embodiments in which a double layer of material is used to form the body of pocket 26, both the exterior surface 26d and the interior surface 26e of pocket 26 will display the patterned side of the material, regardless of whether the pocket is in its regular orientation (as when the cover 10 is mounted to an object or device and exterior surface 26d of pocket 26 is visible, as shown for example in FIGS. 3 and 10) and when pocket 26 is inverted for storing cover 10, exposing interior surface 26e (as shown for example in FIG. 12). Although such a feature of not having any visible seams or other attachment means for securing the pocket 26 to the cover 10 is an aesthetically pleasing feature, it will be appreciated by a person skilled in the art that other embodiments including visible means for attaching the pocket to the exterior surface of the cover 10 are intended to be included within the present disclosure.

Although various embodiments of the cover disclosed herein are illustrated and described as having an exterior surface comprising two portions 20a, 20b and an interior surface comprising two portions 22a, 22b, which are attached together along edges 16, 18 and shoulders 16a, 18a, forming a seam 28 so as to form a tube-like structure, it will be appreciated by a person skilled in the art that the interior and exterior surfaces do not necessarily need to be formed of two portions, and may for example be formed of a single, continuous piece of fabric. Thus, the embodiments described above as including two separate portions for each of the exterior and interior surfaces 20, 22 are not intended to be limiting and it will be appreciated by a person skilled in the art that exterior and interior surfaces formed, for example, from a single piece of fabric or from more than two portions of fabric, are intended to be included within the scope of the present disclosure.

What is claimed is:

1. A multipurpose cover for shielding infants or young children from environmental elements, the cover comprising:
a wholly resilient fabric body defining a cavity therein, the body having an exterior layer, extending from a lower end to an upper end;
the exterior layer having an interior surface and an exterior surface;
the upper and lower ends defining upper and lower openings into the cavity respectively;
the resilient body having a releasable fastener adapted to releasably close a third, vertically extending opening into the exterior layer into the cavity;
wherein the body tapers so as to narrow in width from the lower end to the upper end; and
wherein the cover is adapted to be releasably mounted around and over a circumference of a container so as to at least partially cover an upper opening into the container defined by the circumference.

2. The cover of claim 1 wherein the interior surface comprises a first half and a second half.

3. The cover of claim 1 wherein the interior surface includes a wholly resilient insulating layer.

4. The cover of claim 2 wherein the insulating layer covers the interior surface partially.

5. The cover of claim 2 wherein the insulating layer covers the interior surface wholly.

6. The cover of claim 2 wherein the insulating layer is manufactured from resilient fleece fabric, comprising polyester and Spandex™.

7. The cover of claim 1 wherein the exterior layer is manufactured from breathable mesh fabric.

8. The cover of claim 1 wherein the cavity of the body includes a resilient mesh layer attached to a first side edge and shoulder and a second side edge and shoulder of either the first half or second half of the interior surface.

9. The cover of claim 7 wherein the resilient mesh layer is not attached to the upper end or lower end.

10. The cover of claim 1 wherein the releasable fastener is a two-way zipper.

11. The cover of claim 1 wherein the exterior layer includes at least one pocket.

12. The cover of claim 10 wherein the pocket having a bottom, 1^{st} side and 2^{nd} side, and a pocket opening, is mounted so that the bottom is proximate the lower end of the body and the pocket opening is oriented towards the upper end.

13. The cover of claim 10 wherein the pocket includes a cavity accessed through the pocket opening, wherein the pocket cavity is adapted to store objects.

14. The cover of claim 10 wherein the pocket cavity is adapted to store the body of the cover.

15. The cover of claim 1 wherein the cover is adapted to be used as a breastfeeding cover, wherein the cover is mounted over the shoulders and torso of a breastfeeding caregiver to shield the caregiver's breast and baby from public view.

16. A method of using the multipurpose cover of claim 1 for shielding infants or young children from environmental elements, the method comprising:
providing a wholly resilient fabric body defining a cavity therein, the body having an exterior layer, extending from a lower end to an upper end, wherein:
the exterior layer has an interior surface and an exterior surface;
the upper and lower ends define upper and lower openings into the cavity respectively;
the resilient body has a releasable fastener adapted to releasably close a third, vertically extending opening into the exterior layer into the cavity;
wherein the body tapers so as to narrow in width from the lower end to the upper end; and
wherein the cover is adapted to be releasably mounted around and over a circumference of a container so as to at least partially cover an upper opening into the container defined by the circumference;
placing a child into the container having an opening so that the child is facing out through the opening;
pulling the lower end of the cover over and completely around the perimeter of the opening so that the upper end of the cover extends upwardly over the opening and child; and
adjusting the fastener on the cover between its fully open and full closed positions to allow ventilation for the child and covering for the child adjusted for the environmental conditions.
